(19) United States
(12) Patent Application Publication
(10) Pub. No.: US 2021/0331073 A1
(43) Pub. Date: Oct. 28, 2021

(54) GAMING SYSTEM

(71) Applicant: Jesper Michael Petersen, Frederiksberg (DK)

(72) Inventor: Jesper Michael Petersen, Frederiksberg (DK)

(21) Appl. No.: 16/856,170

(22) Filed: Apr. 23, 2020

(51) Int. Cl. A63F 13/67; A63F 13/58

(52) U.S. Cl. CPC A63F 13/67; A63F 13/58

(57) ABSTRACT

A computer-implemented gaming system and method are disclosed. The system is a three-dimensional multiplayer PC game system that has been designed to allow a plurality of players to access a game at the same time. The system collects the player information from a user participating in the game in a virtual environment for the first time. After entering the game, the system calculates the current position and moving speed of the payer. The position and moving speed of each player are controlled using a game engine. The system then calculates an attack value of the player over other players in the battle. The system enables the player to target and kill as many opponents as possible to win the battle. Further, the system gives a plurality of floating rewards with unpredictable variables for the good gameplay configured to enhance the performance of the player during battles.

### BACKGROUND OF THE INVENTION

### A. Technical Field

The present invention generally relates to a gaming system. More specifically, the present invention relates to a computer-implemented gaming system and method, feature with unpredictable gaming patterns that allow plurality of players to play a game simultaneously.

### B. Description of Related Art

With the continuous growth of technology development, gaming systems have become more popular among people. An important aspect of the gaming system is the ease with which a user can enter desired inputs and interact with the user interface of the device on which he/she plays a game. This typically requires games to be easily understood at their simplest or introductory levels, providing rewarding gameplay with even quite simple game mechanics but becoming progressively more challenging so that players are not bored, but remain engaged and develop rewarding skills.

Computing devices such as tablet computers such as iPads, and smartphones, etc. have extremely user-friendly interfaces, for enabling easy and quick interaction to users thereof. Most of these devices incorporate touch-sensitive screens that obtain user's inputs and facilitate smooth user interaction. Gaming software is employed in many of these devices for leisure purposes.

For devices such as a stationary PC, laptop, and desktop, the user could play the game by clicking an associated mouse, using associated keyboard functions/keys. At present, the shooting game, as one of the action games or battle games, typically uses a virtual camera to implement aiming and shooting. Conventionally, the characters in the battle games are mainly divided up into friends and enemies using two-dimensional coordinates. However, in conventional real-time simulation games, it is not possible to express the power of an actual battle, since the game is mainly a two-dimensional battle, and there was a need for better visibility. Also, with the rapid advance of current computer technology, it is possible to display images on the screen of the TV monitor that is equal to that of movies, however, with the conventional technology there was the problem that games did not have the realistic feeling that players desire.

In light of all the above-mentioned drawbacks, there is a need for a virtual gaming system configured to improve the user experience with unpredictable gameplay patterns. Also, there is a need for a gaming system and method configured to allow a plurality of players to play the game at the same time.

### SUMMARY OF THE INVENTION

The present invention generally discloses the gaming system. Further, the present invention discloses a computer-implemented gaming system and method configured to allow a plurality of players to play a game simultaneously.

According to the present invention, the gaming system is a three-dimensional multiplayer PC game system that has been designed to allow a plurality of players to access a game at the same time. In one embodiment, the system is an application software or web-based application or mobile application. In one embodiment, the application is executed in the computer-implemented environment or network environment.

In one embodiment, the computer-implemented environment comprises one or more gaming servers or computing devices, a network, and one or more user devices. In one embodiment, the server could be a cloud server. The server is configured to collect one or more parameters from the user device. In one embodiment, the server is configured to store databases of player's details, player profiles, high scores, and so on. In one embodiment, the server is configured to store the data function of various games. In one embodiment, the server comprises a processor and a memory unit in communication with the processor. The memory stores a set of instructions executable by the processor to run the game.

In one embodiment, the user device is enabled to access the server via the network. In an exemplary embodiment, the user device is a stationary PC with a display screen, a keyboard, and a mouse. In an exemplary embodiment, the user device is a laptop PC with an external mouse. In some embodiments, the user device could be any one of a desktop, a tablet, a smartphone, a mobile phone, or other suitable electronic communication devices. In one embodiment, the user device comprises a storage medium in communication with the network to access the server. In an embodiment, the network could be a Wi-Fi network, a WiMAX network, a local area network (LAN), a wide area network (WAN), and a wireless local area network (WLAN), cellular network, a satellite communication network, or other suitable communication networks.

In one embodiment, a computer-implemented method for controlling access to a multiplayer battle game in a three-dimensional virtual environment comprises the following steps. At one step, the system collects the player information from a user participating in the game in the virtual environment or world or area. In one embodiment, the virtual environment comprises one or more tropical basin and a swamp, where the player runs under water and above water in the air. At another step, the system calculates the current position and moving speed of the player in the three-dimensional virtual environment. In one embodiment, the position and moving speed of each player is controlled in the three-dimensional virtual environment using a game engine.

In one embodiment, the game engine is configured to move each player at varying speeds in the three-dimensional virtual environment. In one embodiment, the speed of the player under the water is slower than the speed of the player in the air due to the drag force of the water. In one embodiment, the gravity is set to a low value, thereby allowing the player for more flight time. In one embodiment, the gravity is set to high value, thereby stopping the player from flying too high in the air. At another step, the system calculates an attack value expressing the attack power of the player over other players in the battle. At another step, the system allows the player to target and kill as many opponents as possible to win the battle. In one embodiment, the system gives a plurality of floating rewards with unpredictable variables for the good gameplay configured to enhance the performance of the player during battles.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a block diagram of a gaming system used in a computer-implemented environment in an embodiment of the present invention.

FIG. 2 shows a mouse of the user device configured to use in the gaming system in one embodiment of the present invention.

FIG. 3 shows a keyboard of a user device configured to use in the gaming system in one embodiment of the present invention.

FIG. 4 shows a flowchart of a method to play the game in one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

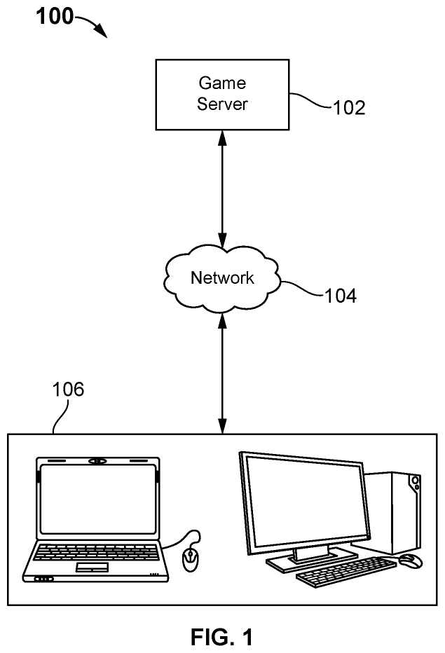

Referring to FIG. 1, a block diagram of a gaming system in a computer-implemented environment 100, according to one embodiment of the present invention. In one embodiment, the system is a three-dimensional multiplayer PC game system that has been designed to allow a plurality of players to access a game at the same time. In one embodiment, the system is an application software or web-based application or mobile application. The application allows the player to play the game. In one embodiment, the application is executed in the computer-implemented environment or network environment 100.

In one embodiment, the computer-implemented environment 100 comprises one or more gaming server or server or computing device 102, a network 104, and one or more user devices 106. In one embodiment, the server 102 could be a cloud server. The server 102 is configured to collect one or more parameters from the user device 106. In one embodiment, the server 102 is configured to store databases of player's details, player profiles, high scores, and so on. In one embodiment, the server 102 is configured to store the data function of various games.

In one embodiment, the server 102 comprises a processor and a memory unit in communication with the processor. The memory stores a set of instructions executable by the processor to run the game. The memory unit could be RAM, ROM (including EPROM, EEPROM, PROM). In one embodiment, the server 102 could be operated as a single computer. In some embodiments, the computer could be a touchscreen and/or non-touchscreen and adopted to run on any type of OS, such as iOS™, Windows™ Android™, Unix™, Linux™ and/or others. In one embodiment, the plurality of computers is in communication with each other, via networks 104. Such communication is established via a software application, a mobile app, a browser, an OS, and/or any combination thereof.

In one embodiment, the user device 106 is enabled to access the server 102 via the network 104. In an exemplary embodiment, the user device 106 is a stationary PC with a display screen, a keyboard, and a mouse. In an exemplary embodiment, the user device 106 is a laptop PC with an external mouse. In some embodiments, the user device 106 could be any one of a desktop, a tablet, a smartphone, a mobile phone, or other suitable electronic communication devices. In one embodiment, the user device 106 comprises a storage medium in communication with the network 104 to access the server 102. In an embodiment, the network 104 could be a Wi-Fi network, a WiMAX network, a local area network (LAN), a wide area network (WAN), and a wireless local area network (WLAN), cellular network, a satellite communication network, or other suitable communication networks.

In one embodiment, the game is coded using the “FlyNew” script. The script in the game run from a downloaded version of the game that the user downloads after purchase and plays from their own user device 106. There is built-in server communication in the game using a photon engine, which is responsible for pairing players based on region. In one embodiment, the game is implemented as a graphically rendered three-dimensional virtual environment or area. The user device 106 renders a graphical visualization of the virtual area and communicates to the server 102 to enable the user to interact and move within the virtual area in X, Y, and Z-axis. In one embodiment, the game allows 10 different players selected from various ethnicities and genders to play in the virtual area at the same time. In one embodiment, the virtual area is set in a walled-off basin of water and small islands. The virtual area has many tropical basins as well as a swamp that all have an abundance of various wildlife.

In one embodiment, each player or player's rigidbody uses the Unity 3D physics engine. In one embodiment, it serves as a rechargeable booster above the sea configured to propel the player to fly above the water surface for a long period of time before splashing back into the water. The water surface is at coordinate 0 on the Y-axis, wherein anything above 0 on the Y-axis is above sea level and anything beneath 0 on the Y-axis is under water. In one embodiment, the player could able to sail faster than a submarine beneath the surface of the water at three different speeds. In one embodiment, the payers could choose to break through the surface of the water and use the momentum gained beneath the sea to fly or glide above the water.

In one embodiment, the game gives rewards such as points, coins, etc. to the player for good gameplay. In an exemplary embodiment, the reward is question mark boxes with weapons configured to upgrade and power-up the floating time in the air above the water surface that is only reachable with momentum and booster. The increased floating time makes it more difficult and demands some foresight amidst the battles.

In one embodiment, the float time is a part of the gameplay to fly up and through the question mark boxes to gain an advantage in the game. In one embodiment, the question mark boxes could vary for every 15 seconds and the upgrades and power-ups only last for a certain amount of time/ammo. The players cannot predict or find the reward in the question mark box, which creates unpredictable gameplay patterns for the payers and allows for beginners as well as professionals to have fun while playing the game together.

In one embodiment, the game has two different modes including a quick-match mode and a tournament mode. The quick-match mode allows for a single match, whereas the tournament mode allows for a series of 10 matches in a row. In one embodiment, the game allows the user to target and kill as many opponents as possible without dying. Each player could respawn 3-5 times per match and then they die. The last player (man or woman) standing after all respawns have been depleted wins.

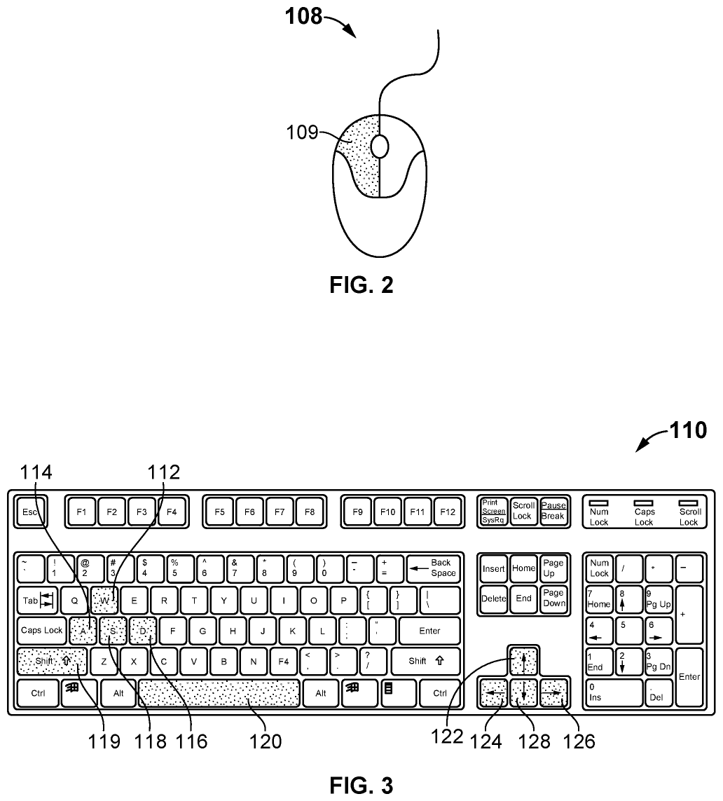

Referring to FIGS. 2 and 3, a mouse 108 and a keyboard 110 used as input devices of the user device 106 to play the three-dimensional multiplayer PC game, according to one embodiment of the present invention. In one embodiment, the mouse 108 is a standard mouse, which could be a wired or wireless device configured to connect with the user device 106. In one embodiment, the mouse 108 uses a left button 109 as a shooting button to play the game. In one embodiment, the keyboard 110 is a standard keyboard, which could be wired or wireless device configured to connect with the user device 106.

In one embodiment, the keyboard 110 uses one or more operational buttons to play the game. The operational keys include, ‘W’ key 112, ‘A’ key 114, ‘D’ key 116, ‘S’ key 118, ‘Left Shift’ key 119, and ‘SPACE’ key 120. ‘W’ key 112 is configured as a speed or forward movement key. ‘A’ key 114 is configured as a left movement key. ‘D’ key 116 is configured as a right movement key. ‘S’ key 118 is configured as a backward movement key. ‘Left Shift’ key 119 is configured as a second gear key. ‘SPACE’ key 120 is configured as a third gear key. In another embodiment, one or more arrow keys such as ‘UP arrow’ key 122, ‘LEFT arrow’ key 124, ‘DOWN arrow’ key 126, and ‘RIGHT arrow’ key 128 are used as alternative movement keys to perform the functions of the operation of keys such as W′ key 112, ‘A’ key 114, ‘D’ key 116, and ‘S’ key 118.

In one embodiment, the speed/power/force is applied to the player using the Unity 3D engine. In one embodiment, the Unity 3D engine is built-in force mode. In one embodiment, the system is configured to show how the player is prompted to move and at which speeds using the Unity 3D engine commands such as AddForce, Gravity, and Drag.

### A. Calculation of Drag Based on the Player Position:

In one embodiment, the drag is calculated for two cases, which includes the player's regidbody or player positioned below or equal to 0 on the Y-axis and above or equal to 0 on the Y-axis. If the player is positioned below or equal to 0 on the Y-axis, the drag is increased to 3. That is the player is simulated to be under water and therefore moves slower due to the drag applied by the water on the player. Then the calculation of drag when the player is under water is represented as follows:

if (player.transform.position.y <= 0)
{

player.drag = 3;
player.mass = 1.7f;

}

If the player is positioned above or equal to 0 on the Y-axis, the drag is decreased to 0. That is the player is simulated to be above water in the air and therefore moves quicker due to no drag applied by the water on the player. Then the calculation of drag when the player is above water is represented as follows:

if (player.transform.position.y >= 0)
{

player.drag = 0;
player.mass = 1.7f;

}

### B. Calculation of Gravity Based on the Player Position:

In one embodiment, the drag is calculated for four cases. If the player is positioned below or equal to −1.45 on the Y-axis, the gravity is set to −12, which simulates under water physics along with the augmented player drag under water. Then the calculation of gravity when the player is under water is represented as follows:

if (player.transform.position.y <= −1.45)

{

Physics.gravity = new Vector3(0, −12f, 0);

}

If the player is positioned above or equal to −1.45 on the Y-axis, the gravity is set to −8. The lower gravity above the water allows for more flight time before falling back into the water. The calculation of gravity when the player is above water is represented as follows:

if (player.transform.position.y >= −1.45)
{

Physics.gravity = new Vector3(0, −8f, 0);

}

As the player flies higher, the gravity increases to stop the player from flying too high. If the player is positioned above or equal to 10 on the Y-axis, the gravity is set to −9. The calculation of gravity when the player is above water is represented as follows:

if (player.transform.position.y >= 10)
{

Physics.gravity = new Vector3(0, −9f, 0);
}

If the player is positioned above or equal to 35 on the Y-axis, the gravity is set to −15, which is very high since there is no drag on the player. The high gravity forces the player to fall back down to the water. The calculation of gravity when the player is above water is represented as follows:

if (player.transform.position.y >= 35)
{

Physics.gravity = new Vector3(0, −15f, 0);

}

### C. Calculation of Speed-1 and Speed-2 Under Water:

If the player is under water (below 0 on the Y-Axis) and the “W” key is held down, Unity3D's AddForce is applied to the player times speed2 (speed2 is a float in the FlyNew script. The float is a numeric value in C# coding) times the numeric value 98, times Time.deltaTime (This allows for steady acceleration over time until the added numeric values are reached). The calculation of Speed-1 and Speed-2 is represented as follows:

if (player.transform.position.y < 0)
{
if (!Input.GetKey(KeyCode.W))
{

//Do Nothing

}
if (Input.GetKey(KeyCode.W))
{

player.AddForce(transform.forward * speed2 * 98f *
Time.deltaTime);

}

### D. Calculation of Speed-3 Under Water:

If the player is under water (below 0 on the Y-Axis) and the “W” key and the “SPACE” key is held down, Unity3D's AddForce is applied to the Rigidbody times speedBoost (speedBoost is a float in the FlyNew script. a float is a numeric value in C# coding). This allows for constant added speed when “W” and “SPACE” keys are held down. If combined with the “Left Shift” key, a maximum speed under water, or speed 3 is obtained. The calculation of Speed-3 is represented as follows:

if (player.transform.position.y <= −1.65f)

{
if (Input.GetKey(KeyCode.Space) )
{

player.AddForce(transform.forward * speedBoost) ;

}
}

### E. Calculation of Boost Above Water:

Speed above water requires momentum gained from underwater speeds and/or boost above water. Boost only works above −1.45 on the Y-Axis and is, in principle, the same as using the “SPACE” key under water except the added force is multiplied by 65 and only works every 2.5 seconds using a Coroutine that resets the “hasCooldown” boolean to false.

If the player is positioned above or equal to −1.45 on the Y-Axis and the player holds down the “SPACE” key AND the boolean “hasCooldown” is false, then Unity3D's AddForce is applied to the Rigidbody times speedBoost times the numeric value of 65 and the coroutine “ActivateCooldownO” is started prompting the boolean “hasCooldown” to be true thus stopping the added force immediately, since it requires the boolean “hasCooldown” to be false. (This creates a short speed burst effect that lets the player fly/glide for a longer period of time and distance.

if (player.transform.position.y >= −1.45)

| | |
|---|---|
| { | if (Input.GetKey(KeyCode.Space) && !hasCooldown) |

{

player.AddForce(transform.forward * speedBoost * 65);
StartCoroutine(ActivateCooldown( ));
}

This is the Coroutine “ActivateCooldownO”. Upon activating the boolean “hasCooldown” becomes true and after 2.5 seconds it returns to being false again, thus allowing for the boost to be used again provided that the player is above water.

IEnumerator ActivateCooldown( )
{

hasCooldown = true;
yield return new WaitForSeconds(2.5f);
hasCooldown = false;
Debug.Log(“boost ready”);

}

### F. Calculation of Lookspeed:

The computer mouse 108 controls the viewing point of the player. The mouse 108 moves around to move the player in front of the camera and the camera is following the player. The forward movement using Unity3D's AddForce combined with the movements of the computer mouse 108, allows the player to move in any and all directions.

The float lookSpeed in the code illustrates how it is quicker to turn and look around above water then beneath it. If the player is positioned above or equal to −1.45 on the Y-Axis, the lookSpeed numeric value is set to 1.5f. When the mouse is rotated to X/Y direction and the input (mouse movement on the X/Y-Axis) and multiply that by the numeric value defined as lookSpeed (1.5f), the player could able to look around faster than under water.

float lookSpeed = 1.5f;

if (player.transform.position.y >= −1.45)
{

rotationX += Input.GetAxis(“Mouse X”) * lookSpeed;
rotationY += Input.GetAxis(“Mouse Y”) * lookSpeed;
transform.localRotation = Quaternion.AngleAxis(rotationX,
Vector3.up);
transform.localRotation *= Quaternion.AngleAxis(rotationY,
Vector3.1eft);

}

The float lookSpeed2 in the code illustrates how it is slower to turn and look around under water. If the player is positioned below or equal to −1.45 on the Y-Axis, the lookSpeed2 numeric value is set to 1.5f. When the mouse is rotated to X/Y direction and the input (mouse movement on the X/Y-Axis) and multiply that by the numeric value defined as lookSpeeds (1f), the player could able to look around more slowly than above water. This along with drag and gravity (See A: Drag and B: Gravity) simulates being under water.

float lookSpeed2 = 1f;

if (player.transform.position.y <= −1.45)
{

rotationX += Input.GetAxis(“Mouse X”) * lookSpeed2;
rotationY += Input.GetAxis(“Mouse Y”) * lookSpeed2;
transform.localRotation = Quaternion.AngleAxis(rotationX,
Vector3.up);
transform.localRotation *= Quaternion.AngleAxis(rotationY,
Vector3.1eft);

}

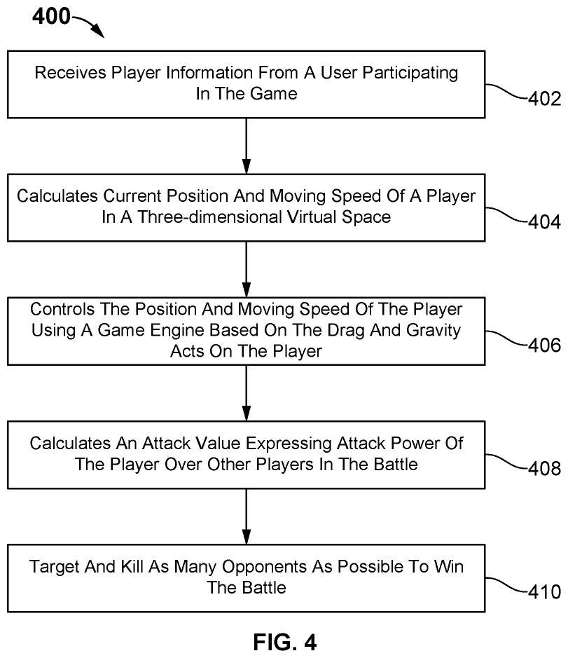

Referring to FIG. 4, a flowchart of a method 400 to play the three-dimensional multiplayer PC game, according to one embodiment of the present invention. In one embodiment, the method 400 comprises the following steps: At step 402, the gaming system receives the player information from the user participating in the game. The system collects the player information such as first name, last name, country, and other details to register into the system when the user playing the game for the first time. In one embodiment, the system could also collect social media account details of the user, thereby allowing the user to connect with the friends in the social media playing the game.

At step 404, the system calculates a current position and moving speed of the player or rigidbody in a three-dimensional virtual environment or virtual world. In one embodiment, the speed/power/force is applied to the player using the unity 3D game engine. In one embodiment, the game engine is built-in force modes. In one embodiment, the game engine is configured to move the players at varying speeds on the X, Y, and Z-axis (i.e., sailing, flying, and thrust). At step 406, the system controls the position and moving speed of the player using the game engine based on the drag and gravity acts on the player. The drag and gravity act on the player could vary when the player is above water and under water.

At step 408, the system calculates an attack value of the player over other players in the battle. In one embodiment, the attack value expresses the attack power of the player over the other players. At step 410, the system enables the player to target and kill as many opponents as possible to win the battle. In one embodiment, each player could respawn 3-5 times per match and then they die. The last player (man or woman) standing after all respawns have been depleted wins.

According to the present invention, the game is not a run-and-gun shooter game, it is a sail-and-fly shooter game with unpredictable variables in the floating question mark boxes, thereby improving the user experience. This sets the game apart from other multiplayer shooting games on any platform including PC. Also, the gaming system allows multiple players to play the game at the same time.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A computer-implemented method for controlling access to a multiplayer battle game implemented in a computing device having a plurality of players that are displayed in a three-dimensional virtual environment, comprising the steps of:
collecting player information from a user participating in the game;
calculating current position and moving speed of the player in the three-dimensional virtual environment;
calculating an attack value expressing attack power of the player over other players in the battle, and
targeting and killing as many opponents as possible to win the battle.

2. The method of claim 1, wherein the position and moving speed of each player is controlled in the three-dimensional virtual environment using a game engine.

3. The method of claim 2, wherein the game engine is configured to move each player at varying speeds in the three-dimensional virtual environment.

4. The method of claim 1, wherein the virtual environment comprises one or more tropical basins and a swamp, where the player sails under the water and flies above the water in the air.

5. The method of claim 1, wherein the speed of the player under the water is slower than the speed of the player in the air due to the drag force of the water.

6. The method of claim 1, wherein the gravity is set to a low value, thereby allowing the player for more flight time.

7. The method of claim 1, wherein the gravity is set to high value, thereby stopping the player from flying too high in the air.

8. The method of claim 1, wherein the system gives a plurality of floating rewards with unpredictable variables for the good gameplay configured to enhance the performance of the player during battles.

9. The method of claim 1, wherein the computing device is at least any one of a personal computer, laptop, or other interactive modern electronic communication devices.

10. The method of claim 1, wherein the computing device is accessed using one or more input devices including, but not limited to, an interactive display screen, a mouse, and a keyboard.
